(19) United States
(12) Patent Application Publication
(10) Pub. No.: US 2024/0336092 A1
(43) Pub. Date: Oct. 10, 2024

(54) METHOD FOR ASCERTAINING THE DEFORMATION OF A TIRE SUBJECTED TO A LOAD WHILE ROLLING

(71) Applicant: COMPAGNIE GENERALE DES ETABLISSEMENTS MICHELIN, Clermont-Ferrand (FR)

(72) Inventors: SIMON NUYTTEN, Clermont-Ferrand (FR); DENIS ALFF, Clermont-Ferrand (FR); DENIS MARTIN, Clermont-Ferrand (FR)

(21) Appl. No.: 18/681,555

(22) PCT Filed: Aug. 1, 2022
(86) PCT No.: PCT/FR2022/051539

§ 371 Date: Feb. 6, 2024

(30) Foreign Application Priority Data
Aug. 6, 2021 (FR) FR2108545

(51) Int. Cl. B60C 11/24; B60C 19/00; B60C 23/06

(52) U.S. Cl. CPC B60C 11/246; B60C 19/00; B60C 23/064; B60C 2019/004

(57) ABSTRACT

A method for ascertaining the deformation of a tire comprises: fastening a sensor to the tire so as to generate an accelerometric signal in the direction normal to the crown; acquiring (201) a temporal wheel-turn signal Sig^{TDR} (101) comprising the amplitude of the acceleration while rolling; determining a reference speed W^{reference} (202) associated with a portion of the wheel-turn signal Sig^{TDR}; normalizing (203) the portion of the wheel-turn signal Sig^{TDR} by a variable which is a function F proportional to the square of W^{reference}; angularly resampling (204) the portion of the wheel-turn signal Sig^{TDR}; defining an energy density S (205) from the angularly resampled normalized wheel-turn signal Sig^{TdR} using a threshold A; and identifying the deformation of the tire Def % (206) as a function G of the energy density S.

### FIELD OF THE INVENTION

The present invention concerns the field of measurement signals supplied by measurement means mounted on the mounted assembly of a terrestrial vehicle while rolling.

### TECHNOLOGICAL BACKGROUND

Recent developments in connected mounted assemblies, measuring physical variables of the mounted assembly by means of on-board sensors in the mounted assembly, lead to determination of the state of the mounted assembly and hence open the door for the development of services linked to monitoring the state of the mounted assembly. Although general variables measured, such as the inflation pressure of the mounted assembly or the temperature of this mounted assembly, are not very sensitive to measurement noise generated by rotation of the mounted assembly on a surface of random roughness since these general variables vary only slightly during rotation of the mounted assembly, finer variables are highly sensitive to physical phenomena linked to the rotation of the mounted assembly. Furthermore, the mounted assembly is subjected to external forces. Some of them are linked to the movement of the mounted assembly such as the rolling resistance. Other forces apply at any instant, and in particular while static, such as load. These applied forces may affect the fine variables to be measured. Finally, new services require cleaning of the physical variables directly measured before obtaining useful information from measurement signals, such as the deformation of the tyre casing.

One of the objects of the invention below is to solve the problems of disruption of measurement signals generated by a sensor so as to obtain only a measurement cleaned of disruption of certain physical phenomena, with the aim of obtaining a vectorial or scalar value, for the deformation of the tyre casing.

In order to gain a better understanding of the invention, the circumferential direction S, axial direction A and radial direction R are directions defined with respect to the rotating frame of reference of the tyre casing about its natural axis of rotation. The radial direction R is the direction extending perpendicularly away from the natural axis of rotation. The axial direction A is the direction parallel to the natural axis of rotation. Finally, the circumferential direction S forms a direct trihedron with the predefined radial and axial directions.

### DESCRIPTION OF THE INVENTION

The invention concerns a method of ascertaining the deformation of a tyre casing. The tyre casing is mounted on a wheel so as to constitute a mounted assembly in rolling state with rotation speed W subjected to a load. The tyre casing has a crown in contact with the ground and in revolution about a natural axis of rotation. The method comprises the following steps:
Fastening at least one sensor to the tyre casing at the crown of the tyre casing so as to generate at least one output signal sensitive to the acceleration, in the direction normal to the crown, applied to said sensor in the tyre casing;
Acquiring at least one first temporal signal Sig comprising at least the amplitude of the at least one output signal while rolling;
Delimiting the first signal over a number N^{TDR} of wheel turns, N^{TDR} being greater than or equal to 1, so as to construct a wheel-turn signal Sig^{TDR};
Determining at least one reference speed W^{reference} associated with at least one portion of the wheel-turn signal Sig^{TDR};
Normalizing the at least one portion of the wheel-turn signal Sig^{TDR} by a variable which is a function F proportional to the square of the reference speed W^{reference}, over a number of wheel turns N′^{TDR}, N′^{TDR} being greater than or equal to 1;
Angularly resampling the at least one portion of the wheel-turn signal Sig^{TDR};
Defining at least one first energy density S from the at least one portion of the angularly resampled normalized wheel-turn signal Sig^{TDR}, named S⁺ when the at least one portion of the angularly resampled normalized wheel-turn signal Sig^{TDR} is greater than a threshold A, or named S⁻ when the at least one portion of the angularly resampled normalized wheel-turn signal Sig^{TDR} is less than or equal to said threshold A;
Identifying the deformation Def % of the tyre casing as a function G of the at least one first energy density S.

The signal recovered from the sensor is the temporal amplitude of the acceleration of the sensor during rolling of the mounted assembly under the specified conditions in the direction normal to the crown. Thus the acquired signal displays the variations in amplitude over a portion of the wheel turn for the tyre casing, including potentially those associated with the crossing of the contact patch by the portion of the tyre casing where the sensor is mounted, but also those associated with other specific zones of the wheel turn, such as that corresponding to the angular sector opposite the contact patch which is susceptible to counter-deflection, or those corresponding to angular sectors situated at 90 degrees from the contact patch relative to the axis of rotation. In all these zones, variations in movement of the accelerometric type sensor can potentially be observed on the output signal depending on the sensitivity of the sensor.

This first acquired signal is associated with a reference speed which can be identified on this first signal or result from another source such as another signal, or the output of a variable by a system external to the mounted assembly. This reference speed is necessarily associated with the same time frame as the portion of the first signal. This reference speed serves to normalize the amplitude of the first signal using a function F, the variable of which is the reference speed. The function F is the power function squared. The sensor signal is normalized as a function of the dependency of the amplitude of the sensor signal on the reference speed, if this dependency is perceived as a parasitic signal of the tyre casing deformation. Thus the first normalized signal becomes independent of this reference speed. For example, this reference speed may be the rotation speed of the mounted assembly, or the translation speed of the mounted assembly in the direction of movement of the mounted assembly. Therefore the first signal may be used independently of the reference speed, which is linked to the rotation of the mounted assembly.

The method also comprises a step of delimiting the first signal Sig over a number of wheel turns with the aim of using the periodicity of the sensor signal to the natural rotation of the tyre casing in rolling condition. However, for this step it is not essential that the number of wheel turns is integral, and the signal may be delimited over an actual number of wheel turns, as long as this number of wheel turns is at least greater than 1. Preferably, several wheel turns are used.

The method also comprises an angular resampling of the first signal or the wheel-turn signal, which may take place before or after the step of normalization. This step allows the temporal signal to be transformed into a spatial signal by phasing the temporal signal relative to one or more angular references of the mounted assembly. This angular reference may firstly be taken from the first signal by a particular response of the sensor to an individual azimuth on the wheel turn. However, this angular reference may also be taken from another signal of a sensor which shares a common timer with the first signal. This shared timer or synchronization of signals is natural if the two sensors are taken from the same device or if the signals are transmitted to a common device. This angular resampling naturally allows generation of a spatial signal periodic to the wheel turn. For this, to generate a perfectly angularly periodic signal, it is sufficient to interpolate the signals over a set angular division. But if the mounted assembly is subject to movement at variable speed, this resampling still allows generation of an angularly periodic signal. It is not essential for the method that the angular resampling generates an output signal with a fixed angular pitch.

Next, simply comparing the level of amplitude of the wheel-turn signal with a threshold A allows generation of an energy density S. The amplitude of the wheel-turn signal relative to a threshold value A, which may for example simply be the unit value, potentially generates a doublet of deformation energy densities, one positive and one negative (S+, S−), from the wheel-turn signal. Thus, the method merely defines a tyre casing deformation energy density and allocates it between two subsets according to its position in relation to the threshold value A. These are operations that are simple to perform and consume little by way of resources.

Finally, the method determines the tyre casing deformation as a function of the calculated energy density. Thus, the deformation represents a deformation energy normalized over one physical wheel turn of the tyre casing. As a result, an energetic invariable connected with the tyre casing deformation subjected to a load in rolling condition is identified. Naturally, a single wheel turn is necessary for the method. However, preferably, the number of wheel turns will be at least 5, or even 10, so that the results can be averaged, which will enable any unpredictable phenomena in the signal to be overcome, such as obstacles on the roadway over which the tyre casing is rolling. Thus, in an industrial mode, the precision of the method is thereby improved.

Advantageously, the step of determining the reference speed W^{reference} consists of establishing the ratio of the angular variation to the temporal duration separating two azimuthal positions of the sensor in the tyre casing around the natural axis of rotation, from the wheel-turn signal Sig^{TDR} or from a signal in phase with the first signal Sig, according to the following formula:

$${W}^{reference} = Δ ( α ) / Δ ( t ) \qquad [ Math 1 ]$$

wherein α is the angular position and t is the temporal abscissa associated with the angular position.

In the case where the reference speed corresponds to the angular rotation speed of the tyre casing, this reference speed is calculated over an angular variation of the signal between two known positions. Preferably, this reference speed is evaluated over a signal duration of less than one wheel turn, which allows rapid definition thereof and performance of the step of normalization of a portion of the first signal at the electronic device associated with the sensor. Moreover, this then allows angular resampling of the portion of the first signal with better precision if the tyre casing moves with a variable angular speed. In fact, at the level of a wheel turn, the variation in angular speed is necessarily small for a tyre with a development which may extend to 2 metres for a car tyre or 3 metres for a truck tyre. The acceleration or deceleration applied to the tyre casing over this length is naturally low with drive and braking systems of current vehicles. Naturally, it is quite possible to integrate a variation in angular speed during the wheel turn with a finer azimuth setting, so as to take account for example of micro-variations in angular speed which occur during the wheel turn, such as for example before and after passing through the contact patch or when encountering a discontinuity in movement over the ground, such as a transverse bar on the ground. This precision of reference speed during a wheel turn then allows a more precise normalization of the signal, but also an increased angular precision in the angular position of the measurement points of the first signal during the angular resampling step, which improves the precision desired for sensing minimal variations during the wheel turn.

According to a particular embodiment, the azimuthal positions of the tyre casing are included in the group comprising an angular position which can be detected from the wheel-turn signal Sig^{TDR}, corresponding to the entry into the contact patch, the exit from the contact patch, or the central position of the contact patch, or any defined angular position from the signal in phase with the wheel-turn signal Sig^{TDR}.

These are azimuthal positions which affect the signal from the acceleration sensor and correspond to specific angular positions. Therefore these positions are easy to identify on the signal from the sensor. Furthermore, it is easy to assign their azimuthal references. In fact the central position of the contact patch corresponds to an azimuthal position of 0 or 180 degrees relative to the normal to the ground. If a contact patch length is determined through the entry and exit points of the contact patch, the angle formed by the contact patch can be established as the ratio of the contact patch length to the development of the tyre casing over one wheel turn or 360 degrees. The sector formed by the contact patch on either side of the normal to the ground is evenly divided. Naturally, access to a signal other than the first signal also allows an angular sectorization which is finer than one wheel turn, as an angular encoder.

Advantageously, the angular pitch is less than 18 degrees.

It can thus be ensured that one of the measurement points is situated in the contact patch. Therefore resulting acceleration variations will be observed at least between this sampling point and its closest neighbouring points, allowing determination of entry and exit points of the contact patch in the first signal.

Highly advantageously, the angular pitch is less than 6 degrees, preferably less than 3 degrees.

Use of a finer angular pitch allows sensing of several measurement points in the contact patch. This fineness of observation allows better precision of the method by avoiding a spatial discretization of points, which is not necessarily regular here. The multitude of points also ensures no disruption due to incoherent measurement by the sensor.

According to a preferred embodiment, the method comprises the step of aggregating the data from the at least one portion of the angularly resampled normalized wheel-turn signal Sig^{TDR} over at least one sub-portion of the at least one portion of the angularly resampled normalized wheel-turn signal Sig^{TDR}, the sub-portion of the at least one portion of the angularly resampled normalized wheel-turn signal Sig^{TDR} becoming the at least one portion of the angularly resampled normalized wheel-turn signal Sig^{TDR}.

Preferably, the sub-portion of the at least one portion of the angularly resampled normalized wheel-turn signal Sig^{TDR} is one wheel turn.

This step allows identification of a wheel-turn signal taking into account variations in the wheel turn, which allows a reduction in the size of vectors to be handled for the final two steps of the method, namely that used to identify the first energy density S. To this end, the sub-portion of the angularly resampled normalized wheel-turn signal is limited to a single wheel turn.

According to a preferred embodiment, the data aggregation step comprises one of the methods contained in the group comprising the mean over a decile interval, the median, the selection or interval of deciles, the methods of interpolation, the weighted or non-weighted mean, optimization of the parametric model of tyre deformation.

The purpose of aggregation is to set the measures performed over a new angular distribution of the first signal in order to make sense of the set of raw measurement data, while not prioritizing one zone over another because of an abundance of measurement points. The aggregation step is intended to supply a balanced signal in terms of measurement points with an angular pitch selected by the operator according to the tyre casing deformation to be observed. To this end, the method of optimizing the parametric model of the tyre deformation is ideal, since this parametric model may be theoretical, not taking into account measurement noise linked to the entire measurement chain applied. The output signal from the aggregation step is a theoretical output of the parametric model having minimal spread with the set of measurement points recorded.

Advantageously, having phased the first signal Sig with respect to an angular position of the tyre casing, a correction Corr is made to the first signal Sig to take account of the effect of terrestrial gravity before the normalization stage.

The drawback of the accelerometric signal is that it is sensitive to terrestrial gravity if oriented approximately parallel to terrestrial gravity. In the case of the tyre casing, the sensor is rotationally linked to the tyre casing. Therefore when the sensor is oriented radially, the amplitude of the sensor signal is influenced by terrestrial gravity during a wheel turn. This is reflected in the signal in the form of a sinusoidal function of amplitude linked to terrestrial gravity, with nodes at the azimuths of the tyre casing separated by 180 degrees when the orientation of the sensor is aligned with the gravitational vector, i.e. substantially perpendicular to the ground. Conversely, when the sensor is oriented parallel to the ground, which corresponds to two azimuthal positions separated from one another by 180 degrees and generally situated at approximately +/−90 degrees from the gravitational vector, the sensor signal is not influenced by terrestrial gravity. In order to eliminate this parasitic component of the accelerometric signal, the amplitude of the signal should be combined with a corresponding sinusoidal function, by having phased the first sensor signal with the vertical to the ground corresponding to the direction of the gravitational vector.

According to a particular embodiment, the method comprises a step of filtering the at least one portion of the angularly resampled normalized wheel-turn signal Sig.

High-frequency interference may remain on the angularly resampled normalized signal, which will be processed in the following step of defining the first energy density S using the threshold A. However, filtering the signal will simplify the following step by minimizing possible errors.

As a preference, threshold A is between 0.5 and 0.9.

The purpose of the threshold is to distribute the discretized points of the angularly resampled normalized wheel-turn signal Sig^{TDR} between the energy densities S⁺ and S⁻. If the signal carries a lot of noise, as in the absence of the data aggregation step or the filtering step, this distribution of points may be influenced by this interference. The purpose of the threshold A is to correct this imperfection linked to the measuring signal. The value of threshold A is a function of the quality of the angularly resampled normalized wheel-turn signal Sig^{TDR}. If the method takes the optional steps and the roughness of the road is low, a value at the top of the range will be preferred.

Highly preferably, the definition of the positive S⁺ and negative S⁻ energy densities is obtained by the following formulae:

$${S}^{+} = ⌈ {\sum }_{{Sig}^{TDR} > A} ( {Sig}^{TDR} - 1 ) ⌉ * \frac{{N}^{′ TDR}}{{N}^{U}} ; and \qquad [ Math 2 a ]$$

$${S}^{-} = ⌈ {\sum }_{{Sig}^{TDR} \leq A} ( {Sig}^{TDR} - 1 ) ⌉ * \frac{{N}^{′ TDR}}{{N}^{U}} ; \qquad [ Math 2 b ]$$

wherein u is the abscissa value of the angularly resampled normalized wheel-turn signal Sig^{TDR}.

This is a simple way of obtaining a scalar value of each energy density from the discretized signal from the angularly resampled normalized wheel-turn signal using elementary mathematical and logical operations. These operations may take place in the electronic device linked to the sensor.

Preferably, the first signal is acquired at a constant sampling frequency and the spatial discretization for sampling the first signal is less than 6 degrees, preferably less than 3 degrees, very preferably less than 1 degree.

For example, if it is desired that the evaluation of the deformation of the tyre casing takes place at the mounted assembly, the sensor must be associated with an electronic element comprising a microcontroller, a memory, a battery and a clock. Then, the envisaged spatial discretization with a constant sampling frequency makes it possible to carry out simple operations at the microcontroller, minimizing the energy consumption of the battery. In addition, the minimum discretization of about 60 points on the wheel turn makes it possible to limit the number of operations and transfer to the memory. Furthermore, the accuracy obtained with regard to the deformation of the tyre casing is good while still having made a saving on the battery of the electronic element. This makes it possible to store or transfer only intermediate scalar values of the method.

Advantageously, the function G is a linear function of the spectral density S according to the following formula:

$$G ( X ) = X / {N}^{′ TdR} \qquad [ Math 3 a ]$$

Thus this is an elementary formula for the tyre casing deformation which applies either to S⁺ or S⁻. Necessarily, S⁻ corresponds to the energy density calculated from material points of the development of the tyre which, at a precise moment in time T, include those in the contact patch or in the immediate vicinity thereof. Specifically, these points have an absolute acceleration close to zero when passing through the contact patch, and so they are necessarily below the threshold value A. By default, the energy density S⁺ corresponds to the energy density of the other points on the development of the tyre and notably those outside the contact patch. That demonstrates that there is an invariable connected with the tyre casing deformation subjected to a load Z. In instances in which it is only S⁺ that is used, there is no need to have a high spatial discretization because the variations outside of the contact patch are not as significant. The advantage of this is to reduce the necessary sampling frequency of the electronic device coupled to the sensor or to be able to obtain precise information on the tyre casing deformation at high rotational speeds.

Very advantageously, function G is a linear function of the spectral densities S⁺ and S⁻, according to the following formula:

$$G ( X , Y ) = ( X + Y ) / ( 2 * {N}^{′ TdR} ) \qquad [ Math 3 b ]$$

In that case, the tyre deformation energy needs to be summed around the entire development of the tyre. In order to be certain of minimizing measurement uncertainties, use is then made of the set of measurement points for measuring the acceleration normal to the crown in order to determine the tyre casing deformation, which makes it possible to reduce the energy consumption in comparison with an analysis employing a signal having a higher sampling frequency.

### BRIEF DESCRIPTION OF THE DRAWINGS

The invention will be better understood upon reading the following description, which is provided solely by way of a non-limiting example and with reference to the accompanying figures, in which the same reference numbers in all cases designate identical parts and in which:

FIG. 1 shows an overview of the method according to the invention.

FIG. 2 shows an illustration of a first signal from a sensor.

FIG. 3 shows the angular resampling of the wheel-turn signal.

FIG. 4 shows an illustration of the resampled normalized wheel-turn signal.

FIG. 5 shows an illustration of the final signal after data aggregation over a sub-portion of the wheel-turn signal.

FIG. 6 is an illustration of evaluation of the energy densities S from the angularly resampled normalized wheel-turn signal.

### DETAILED DESCRIPTION OF EMBODIMENTS

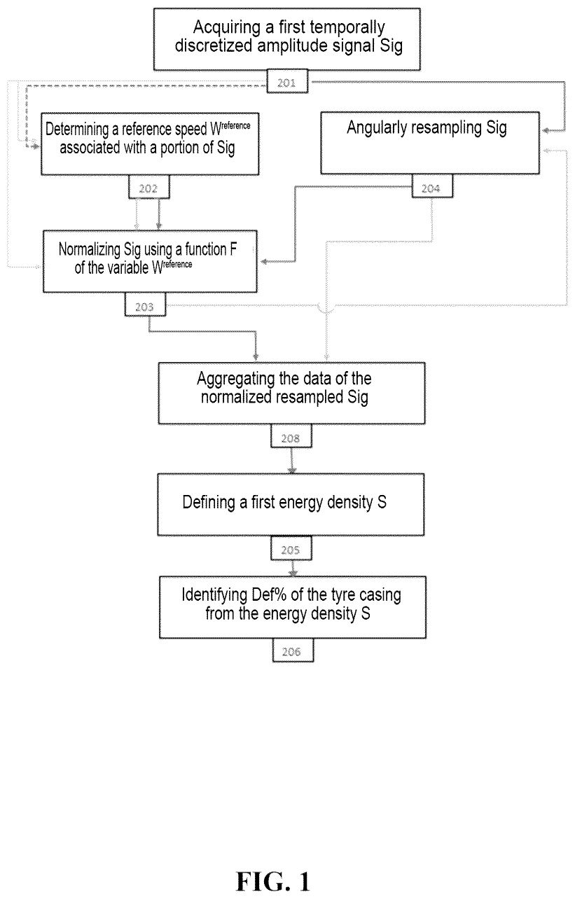

FIG. 1 shows an overview of the method according to the invention. From a first signal Sig obtained by temporal acquisition 201 of the amplitude output of a movement sensor during rolling of the tyre casing on which the sensor is mounted, a number of steps are performed following various possible pathways for obtaining a scalar representative of the deformation of the tyre casing finally.

The first pathway comprises, from the temporal signal at the output of step 201, determining a reference speed W^{reference} 202 of the tyre casing in its mounted assembly configuration, i.e. tyre casing mounted on rim and inflated. Here, the first signal Sig 101 is already delimited over a certain number of wheel turns, 12 to be precise. Consequently, the first signal Sig 101 coincides with the wheel-turn signal Sig^{TDR}. This reference speed may be an angular speed linked to the natural rotation of the tyre casing around its rotational axis, but it may also be the translation speed per unit length of the tyre casing in the direction of travel thereof. This value may be determined from the wheel-turn signal Sig^{TDR} but also determined from another signal temporally in phase with the first signal and hence the wheel-turn signal Sig^{TDR}.

Then the wheel-turn signal is normalized 203 from the first signal resulting from step 201 by a function F of the variable W^{reference} acquired in step 2. This function is the power function squared. After this step 203, a normalized signal is obtained for the movement of the tyre casing in a temporal description.

The normalized signal must then be angularly resampled in order to find a signal which is angularly periodic to the wheel turn through step 204. Then after this step 204, the result is a signal normalized and angularly resampled over several wheel turns.

The second pathway comprises, from the first signal Sig which is also the wheel-turn signal Sig^{TDR} resulting from step 201, angularly resampling the first signal Sig by phasing this first signal by means of the form of the first signal or by having another signal temporally phased with the first signal. The other signal comes from another sensor, or another track of the same sensor, such as the circumferential acceleration of a three-dimensional accelerometer. This angular resampling of the first signal leads to a signal periodic to the wheel turn at the end of step 204.

After having phased this angular signal using another temporal signal, a reference speed is determined from another temporal signal in phase with the first signal. Preferably, this is the same other signal which was used for angularly resampling the first signal in step 204. Thus a reference speed W^{reference} is identified at the end of step 202.

Then the reference speed allows normalizing of the angularly resampled signal from step 204 using a function of the reference speed variable. This gives an angularly resampled normalized wheel-turn signal Sig^{TDR} at the end of step 203.

Optionally, whichever pathway is taken, the data from the angularly resampled normalized wheel-turn signal Sig^{TDR} resulting from step 204 on the first pathway or step 203 on the second pathway are aggregated. This data aggregation is carried out on a sub-portion of the input signal which is a single wheel turn, since the angularly resampled normalized signal is periodic to the wheel turn by its nature.

Alternatively, if the first signal 101 is polluted by known physical phenomena such as an accelerometer signal influenced by terrestrial gravity, it is sometimes useful—although not essential—to perform a correction of the first signal for this physical phenomenon in order to limit the parasitic noise generated by the physical phenomenon. This correction may take place at any step between step 201 and 204, but necessarily before the data aggregation step 205, which allows an improvement in the quality of the signal for tyre casing deformation. If correction takes place after the normalization step, the correction must also be normalized so as not to introduce a correction error.

Then the method comprises a step of identifying 205 an energy density for the tyre casing deformation from the angularly resampled normalized wheel-turn signal. Although this may be performed on only a portion of the wheel turn through the positive energy density S⁺ or negative energy density S⁻, it is preferable to take at least one complete wheel turn, which gives access to both said variables. Nor must it be forgotten to record the number of wheel turns N′^{TDR} over the angularly resampled normalized wheel-turn signal. If this signal is delimited over one wheel turn, identification of the energy densities is linked to the quality of the signal, which justifies using the optional step of data aggregation. However, if this signal is delimited over a large number of wheel turns, the signal may contain an additional fraction of a wheel turn which will only slightly modify the value of the energy density. In this case it would be preferable to count the wheel turns from the azimuthal position situated at 180 degrees from the centre of the contact patch. The additional fractions of a wheel turn will provide complementary points for the positive energy density S⁺, the variations of which between the points are smaller than during the contact patch entry and exit phases which have a greater effect on the negative energy density S⁻.

Finally the method comprises a step 206 of identifying the tyre casing deformation in rolling condition under static load Def %. This is achieved using the energy density or densities S⁺, S⁻ evaluated in step 205 by means of a function G.

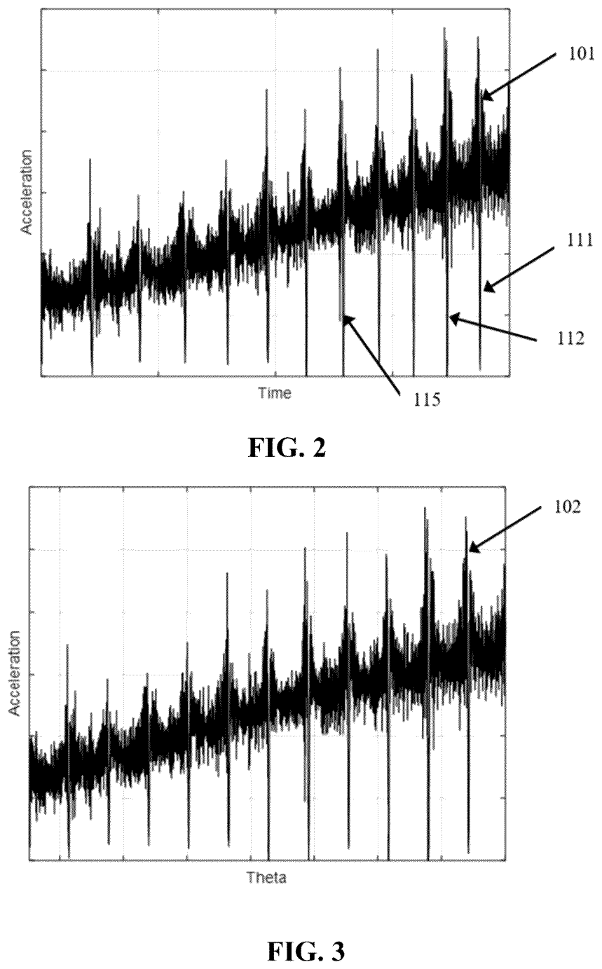

FIGS. 2 to 4 illustrate the method using the second pathway described in the overview of FIG. 1. The illustration is given for an accelerometer fixed at the crown of a tyre casing mounted on the inner liner of the tyre casing. Here, the tyre casing is a MICHELIN CrossClimate in size 265/65R17 under a static load of 800daN when mounted on a motor vehicle. The mounted assembly was inflated to 3 bar. Measurements were performed during travel of the vehicle on asphalt circuits with varying roughness, under standard conditions of speed and load applied according to the tyre marking. The mounted assembly was situated on the front axle of the vehicle. The measurements here were performed mostly in straight-line travel.

FIG. 2 shows a temporal signal 101 acquired with a signal acquisition frequency of 3200 Hz, allowing very fine discretization of the signal. This therefore records all variations in acceleration at the crown of the tyre casing during rolling. This was delimited over 12 wheel turns in order to constitute the wheel-turn signal Sig^{TDR}.

The recording in FIG. 2 was performed in an acceleration phase of the vehicle, which is reflected by an increase in the amplitude of the accelerometric signal. The sensor here is a single-axis accelerometer mounted radially relative to the crown of the tyre casing, before creation of the mounted assembly by conventional fixing techniques known in the prior art. The data were transmitted by wireless communication between an electronic device galvanically connected to the accelerometer and a second radiofrequency device placed in the vehicle. In this particular case, the post-processing of the measurements was performed in the vehicle. However, it is quite possible to perform these in a first electronic device connected to the sensor, equipped with a microcontroller or microprocessor and coupled to sufficient memory space to perform the elementary mathematical operations required by the method.

Here, the first step consists of determining the reference speed, taking as reference speed the angular rotation speed. For this, the first temporal signal 101 must be phased with a reference azimuthal position of the wheel turn. To this end, the first signal 101 shows regular quite strong falls in amplitude 111, 112 which reflect the passage through the contact patch of the angular sector carrying the accelerometer. Naturally, these downward and upward slopes of the falls 111, 112 represent respectively the entry and exit of the contact patch. The centre of the contact patch is the middle of the interval separating the entry and exit of the contact patch. This centre is assigned the azimuthal position of 0 degrees which will be our azimuthal reference. By taking a second angular reference on the next signal fall 112 for example, the signal 101 is determined for a wheel turn of 360 degrees and a temporal interval associated with this wheel turn. The reference speed W^{reference} is defined as the ratio of angular variation between the two centres of the contact patch to the temporal interval separating these two azimuthal positions. This reference speed W^{reference} is assigned to the portion of the signal situated between these two centres of the contact area. Naturally, two non-contiguous falls 111, 115 of the temporal signal 101 could be considered for determining a second reference speed W^{reference} and assigning the second speed to the portion of the signal 101 situated between the two falls 111, 115.

FIG. 3 shows the result of the step of angular resampling of the temporal signal 101. Thus, using the determination of the centres of the contact patch for each fall in temporal signal performed in the preceding step, it is easy to phase the temporal signal with the wheel turn over 360 degrees. Then the discretized measurement points are linearly distributed over the wheel turn. Even if an angular positioning error is made at this step, a linear interpolation performed for example during the data aggregation step will smooth out the results and minimize the angular positioning error. In a more sophisticated fashion, a reference speed is evaluated on each wheel turn. It is possible to assign evolving angular speeds to the wheel turn by taking into account reference speeds of contiguous turns. For example, having determined the reference speeds over three consecutive turns, it is possible to assign to the central wheel turn a first reference speed for the first quarter wheel turn, being the barycentric speed of the reference speed of the preceding weighted turn 2 and the reference speed of the current weighted turn 1. The following quarter will have a reference speed being the barycentric speed of the reference speed of the current weighted turn 2 and the reference speed of the preceding weighted turn 1. The third quarter wheel turn will have a reference speed being the barycentric speed of the reference speed of the current weighted turn 2 and the reference speed of the next weighted turn 1. Finally, the last quarter wheel turn will have a reference speed being the barycentric speed of the reference speed of the current weighted turn 1 and the reference speed of the next weighted turn 2. All discretized measurement points are distributed over each quarter wheel turn in proportion to the ratio of reference speeds of each quarter turn to the reference speed of the current turn. Other methods for smoothing the points may also be applied. Here, the spatial discretization of points is not regular because of the variable rolling speed. It is quite possible to make this discretization of points of signal 102 regular by applying a method of interpolating measurement points over a given angular distribution for the wheel turn. This then provides an angularly resampled signal 102 with a regular angular pitch. FIG. 3 shows the angularly resampled signal 102 which is periodic to the wheel turn with arbitrary discretization of measurement points.

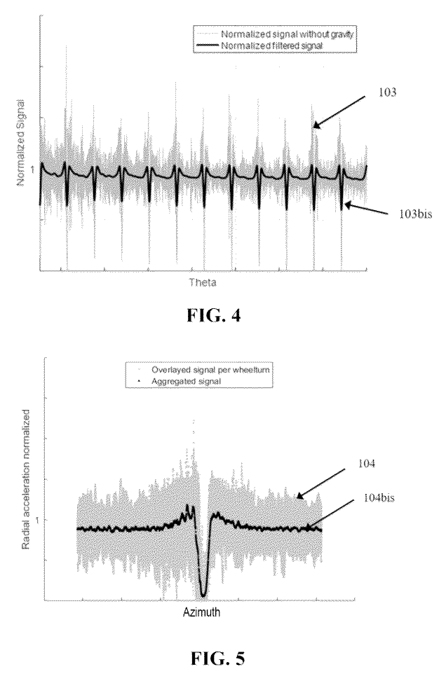

FIG. 4 shows the result of the step of normalizing the first angularly resampled signal 102 without interpolation of points. Thus, using the periodicity to the wheel turn of the angularly resampled wheel-turn signal, it is easy to break down the angular signal over a wheel turn or over a multiple of the wheel turn as illustrated in FIG. 4, here 12 wheel turns. The normalization step consists of dividing the amplitude of the signal by the power function squared of the reference speed associated with each portion of a wheel turn. The reference speed was determined during the first signal processing step 101 for example. The reference speed is an angular speed. The result observed on curves 103 and 103bis is that the amplitude of the normalized signal is similar for each wheel turn. We no longer see the strong variations in amplitude between the various wheel turns performed at difference speeds and on different roads. Also, the signal is centred on the unit value. Then the wheel turn segments are superposed over the same angular interval of a length which is an integral multiple of 360 degrees, as shown by the grey curves which here form a curve bundle 103. This takes into account the spread of measurements between wheel turns, which is accentuated by the fact that the signals have not been corrected for terrestrial gravity. However, if a low-pass filter is applied, we obtain black curve 103bis which is smoother since cleaned of certain parasitic noise. This allows us to see that signal 103bis is periodic to the wheel turn with slight variations between wheel turns. At the end of this normalization of signal 102, we obtain an angularly resampled normalized signal 103. FIG. 4 shows the angularly resampled normalized signal 103 which is centred on the unit value, as confirmed by the filter applied to curve 103bis.

FIG. 5 is the result of the step of aggregation of the data from signal 103 from the preceding step, which is an optional step. Here, the segments of each wheel turn are superposed over the same angular interval of a length of 360 degrees, as shown by the grey curves which here form a curve bundle 104. This takes into account the spread of measurements between each wheel turn, which is accentuated by the fact that the signals have not been corrected for terrestrial gravity. However, if we apply a correction for terrestrial gravity to each wheel turn before the normalization step, since the accelerometer is here sensitive to terrestrial gravity, data aggregation by a method of the mean over a decile interval determines the curve 104bis, which is much more stable for the wheel turn. This gives a signal for tyre casing deformation subjected to external forces, in particular the static load in this case. This signal 104bis is representative of the measurement of the tyre casing in rolling condition at variable speed on ground of any roughness. This curve is an invariant of the tyre casing in rolling condition under static load in a state mounted on the rim.

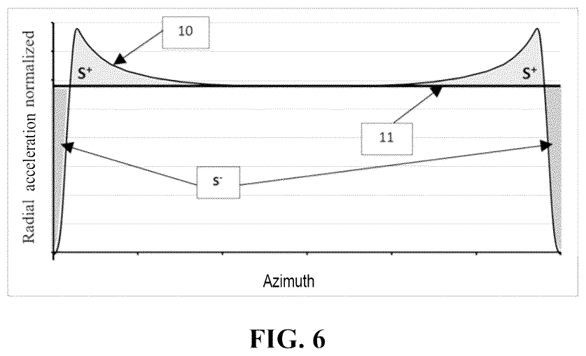

FIG. 6 is an illustration to explain the computation of the positive S⁺ and negative S⁻ energy densities on an angularly resampled normalized wheel-turn signal Sig^{TDR} corresponding to a single wheel turn. Naturally, the method is identical if the angularly resampled normalized wheel-turn signal Sig^{TDR} is delimited over several wheel turns.

The threshold A is determined as being the unit value here. This threshold is shown by the solid line 11. In fact, adopting a value equal to 0.7 is preferable on real signals. If there is a lot of interference on the signals, then a value equal to 0.5 or 0.6 may be chosen. However, for signals obtained on generally smooth road surfaces, a value of the order of 0.8 or 0.9 can be used. This value A must be set for all the steps of the method.

The positive S⁺ or negative S⁻ energy densities are calculated as the sum of the absolute values of the differences between the wheel-turn signal 10 and the unit value represented by the continuous curve 11. Necessarily, the area delimited by the areas S⁺ is equal to the area delimited by the area S⁻.

From the estimate of these energy densities S, it is easy to determine the tyre casing deformation Def % subjected to a static load in rolling condition.

1.-13. (canceled)

14. A method for ascertaining a deformation of a tire casing subjected to a load when mounted on a wheel so as to constitute a pneumatic mounted assembly in rolling state with rotation speed W, the tire casing having a crown, intended to be in contact with a ground, and in revolution about a natural rotational axis, comprising the following steps:
fastening at least one sensor to the tire casing at the crown of the tire casing so as to generate at least one output signal sensitive to acceleration, in a direction normal to the crown, applied to the at least one sensor in the tire casing;
acquiring (201) at least one first temporal signal Sig comprising at least an amplitude of the at least one output signal while rolling;
delimiting the first signal Sig over a number N^{TdR} of wheel turns so as to construct a wheel-turn signal Sig^{TdR}, N^{TdR} being greater than 1;
determining at least one reference speed W^{reference} (202) associated with at least one portion of the wheel-turn signal Sig^{TdR};
normalizing (203) the at least one portion of the wheel-turn signal Sig^{TdR} by a variable which is a function F proportional to a square of the reference speed W^{reference}, over a number of wheel turns N′^{TdR}, N′^{TdR} being greater than or equal to 1;
angularly resampling (204) the at least one portion of the wheel-turn signal Sig^{TdR};
defining at least one first energy density S (205) from the at least one portion of the angularly resampled normalized wheel-turn signal Sig^{TdR}, S+ when the at least one portion of the angularly resampled normalized wheel-turn signal Sig^{TdR} is greater than a threshold A or S− when the at least one portion of the angularly resampled normalized wheel-turn signal Sig^{TdR} is less than or equal to the threshold A; and
identifying a deformation Def % (206) of the tire casing as a function G of the at least one first energy density S.

15. The method for ascertaining the deformation of a tire casing subjected to a load according to claim 14, wherein the step of determining the reference speed W^{reference} (202) consists of establishing a ratio of an angular variation to a temporal duration separating two azimuthal positions of the at least one sensor in the tire casing around the natural rotational axis, from the first signal Sig or from a signal in phase with the first signal Sig, according to the following formula:
$${W}^{Reference} = \frac{Δ ( α )}{Δ ( t )} \qquad [ Math 1 ]$$
wherein α is an angular position and t is a temporal abscissa associated with the angular position.

16. The method for ascertaining the deformation of a tire casing subjected to a load according to claim 14, wherein an angular pitch is less than 18 degrees.

17. The method for ascertaining the deformation of a tire casing subjected to a load according to claim 14, further comprising a step of aggregating data from the at least one portion of the angularly resampled normalized wheel-turn signal Sig^{TdR} over at least one sub-portion of the at least one portion of the angularly resampled normalized wheel-turn signal Sig^{TdR}, the at least one sub-portion of the at least one portion of the angularly resampled normalized wheel-turn signal Sig^{TdR} becoming the at least one portion of the angularly resampled normalized wheel-turn signal Sig^{TdR}.

18. The method for ascertaining the deformation of a tire casing subjected to a load according to claim 17, wherein the at least one sub-portion of the at least one portion of the angularly resampled normalized wheel-turn signal Sig^{TdR} is one wheel turn.

19. The method for ascertaining the deformation of a tire casing subjected to a load according to claim 17, wherein the data aggregation step (205) comprises a method selected from the group consisting of a mean over a decile interval, a median, a selection or interval of deciles, methods of interpolation, a weighted or non-weighted mean, and optimization of a parametric model of tire deformation.

20. The method for ascertaining the deformation of a tire casing subjected to a load according to claim 14, wherein having phased the first signal Sig with respect to an angular position of the tire casing, a correction Corr is made to the first signal Sig to take account of an effect of terrestrial gravity before the normalization step.

21. The method for ascertaining the deformation of a tire casing subjected to a load according to claim 14, further comprising a step of filtering the at least one portion of the angularly resampled normalized wheel-turn signal Sig^{TdR}.

22. The method for ascertaining the deformation of a tire casing subjected to a load according to claim 14, wherein the threshold A is between 0.5 and 0.9.

23. The method for ascertaining the deformation of a tire casing subjected to a load according to claim 14, wherein the positive energy density S+ and negative energy density S− are obtained by the following formulae:
$${S}^{+} = ⌈ {\sum }_{{Sig}^{TDR} > A} ( {Sig}^{TDR} - 1 ) ⌉ * \frac{{N}^{′ TDR}}{{N}^{U}} ; and \qquad [ Math 2 a ]$$
$${S}^{-} = ⌈ {\sum }_{{Sig}^{TDR} \leq A} ( {Sig}^{TDR} - 1 ) ⌉ * \frac{{N}^{′ TDR}}{{N}^{U}} ; \qquad [ Math 2 b ]$$
where N is a total number of discretized points on the angularly resampled normalized wheel-turn signal Sig^{TDR}.

24. The method for ascertaining the deformation of tire casing according to claim 23, wherein the first signal is acquired at a constant sampling frequency and a spatial discretization for sampling the first signal is less than 6 degrees.

25. The method for ascertaining the deformation of a tire casing subjected to a load according to claim 14, wherein the function G is a linear function of the spectral density S according to the following formula:
$$G ( X ) = X / {N}^{′ TdR} . \qquad [ Math 3 a ]$$

26. The method for ascertaining the deformation of a tire casing according to claim 14, wherein the function G is a linear function of the spectral densities S+ and S− according to the following formula:
$$G ( X , Y ) = ( X + Y ) / ( 2 * {N}^{′ TdR} ) . \qquad [ Math 3 b ]$$
